(19) United States
(12) Patent Application Publication
(10) Pub. No.: US 2006/0070923 A1
(43) Pub. Date: Apr. 6, 2006

(54) Rotor for fibrous suspension strainers

(76) Inventor: Giancarlo Dal Maso, Schio (IT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/994,370

(22) Filed: Nov. 23, 2004

(30) Foreign Application Priority Data
Sep. 2, 2004 (IT) VI2004A000208

(51) Int. Cl. B07B 1/04

(52) U.S. Cl. 209/273

(57) ABSTRACT

A rotor for fibrous suspension strainers, having a central body with substantially circular cross section is formed with a bottom base, a top base and a vertical rotation axis and a plurality of shaped blades protruding from the outer lateral surface of the central body. In each blade the direction defined by at least one of the front edges is inclined in the direction opposite the direction of rotation of the rotor and forms an acute angle with any other coplanar direction that intersects it, defined by the intersection of the blade and any vertical sectioning plane passing through the vertical rotation axis.

### BACKGROUND OF THE INVENTION

The invention concerns an improved rotor for fibrous suspension strainers.

In particular, the rotor object of the invention can be applied to any strainer used in the papermaking industry to clean fibrous suspensions, especially those deriving from recycled paper and cardboard, in which contaminants of the type with filaments are present.

It is known that to remove the contaminants present in the fibrous suspensions used in the papermaking industry special strainers are used, comprising a filtering basket provided with a rotor with wing-shaped blades that force the suspension through the holes present in the filtering basket.

The filtered suspension that passes through the holes of the filtering basket is commonly indicated as “accepted”, while the part of the suspension that still contains contaminants is called “rejected” and is further processed in order to recover the fibre that is still present in it.

When the fibrous suspensions to be filtered derive from recycled maceration paper constituted, for example, by cardboard, they contain contaminants of the type with filaments that stick to the rotor blades, where they accumulate, thus affecting the correct operation of the strainer.

In fact, in the rotors of the known type the blades have profiles and shapes that facilitate the accumulation of these polluting substances with filaments, which must be periodically removed through suitable maintenance operations.

Since these maintenance operations must necessarily be carried out with the machine at rest, this involves, in addition to the cost of the maintenance operation, the cost related to the production stop due to system down time.

The present invention aims to overcome the drawbacks listed above.

### SUMMARY OF THE INVENTION

In particular, it is a first aim of the invention to achieve an improved rotor for fibrous suspension strainers that compared to the known rotors has a reduced tendency to retain the contaminants with filaments.

It is a further aim of the invention to achieve a rotor that can be applied to any strainer with filtering basket of the known type.

The last but equally important aim is to construct the rotor object of the invention so that the service time required for its cleaning is reduced.

The aims mentioned above are achieved by a rotor for fibrous suspension strainers that, in accordance with the main claim, comprises:
a central body with substantially circular cross section, in which it is possible to identify a bottom, a top and a vertical rotation axis;
a plurality of shaped blades protruding from the outer lateral surface of said central body,

and wherein in each one of said blades the direction defined by at least one of the front edges is inclined in the opposite direction with respect to the direction of rotation of said rotor and forms an acute angle with any other coplanar direction that intersects it, defined by the intersection of said blade and any vertical sectioning plane passing through said vertical rotation axis.

According to a favourite embodiment of the invention, each shaped blade has a wing-shaped surface that develops parallel to the vertical axis of the central body to which it is applied on the outer lateral surface by means of a connection element.

The front edges of the wing-shaped surface and of the connection element, also called “connection edges” because they are the first to make contact with the suspension to be treated, are inclined in the direction opposite the direction of rotation of the rotor.

In this way it is possible to avoid the creation of undercut areas or corners that provide grip for any contaminants with filaments, since the profile of the front edge of the blades, being receding with respect to the direction of rotation of the rotor, facilitates their detachment and allows them to slide towards the end of the blade.

Advantageously, the rotor object of the invention requires less maintenance than the known rotors.

Still to advantage, the rotor object of the invention makes the strainer to which it is applied more efficient.

Advantageously, since the profile of the blades of the rotor object of the invention is such that the detachment of the polluting substances is easier, the latter remain inside the strainer for a shorter time than it would be required in case of use of rotors of the known type.

Consequently, the wear of all the parts of the strainer that make contact with such polluting substances during processing is also reduced.

It is equally advantageous that the rotor object of the invention can be applied to strainers with filtering basket of any type.

### BRIEF DESCRIPTION OF THE DRAWINGS

The aims and advantages described above will be explained in greater detail in the description of a favourite embodiment of the invention given as an example without limitation with reference to the attached drawings, wherein:

FIG. 1 is an axonometric view of the rotor object of the invention;

FIG. 2 is an exploded view of the rotor of FIG. 1;

FIG. 3 shows an enlarged detail of the rotor of FIG. 1;

FIG. 4 shows the development of the rotor of FIG. 1;

FIG. 5 shows a detail of FIG. 4;

FIG. 6 is a top view of FIG. 5;

FIG. 7 shows another detail of FIG. 4;

FIG. 8 is the top view of the detail shown in FIG. 7;

FIG. 9 shows a cross section of the rotor of FIG. 1;

FIG. 10 shows a detail of FIG. 9.

### DESCRIPTION OF THE INVENTION

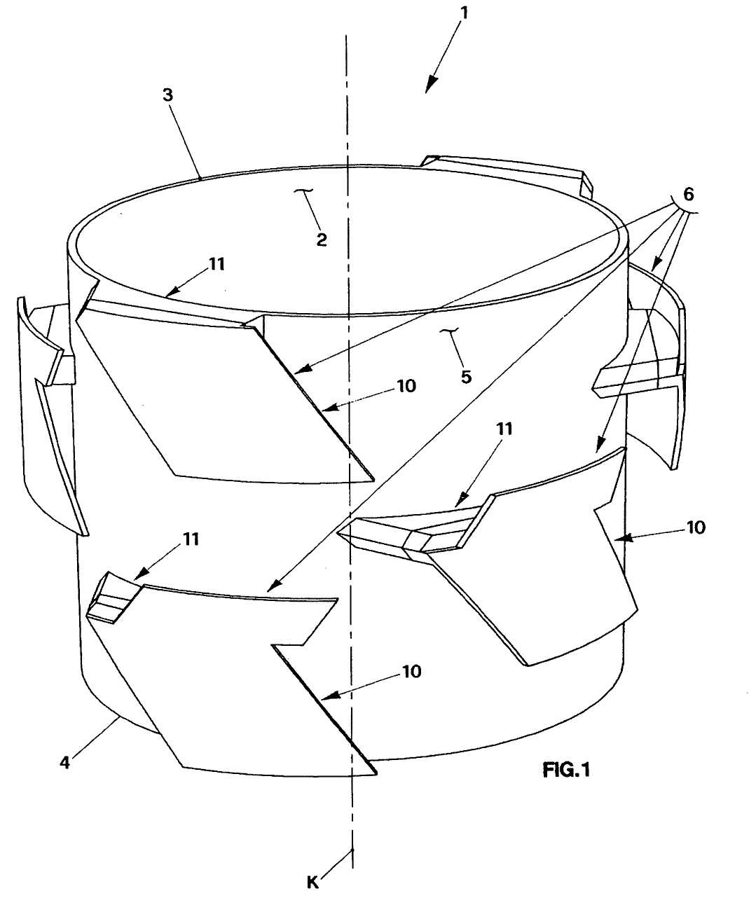

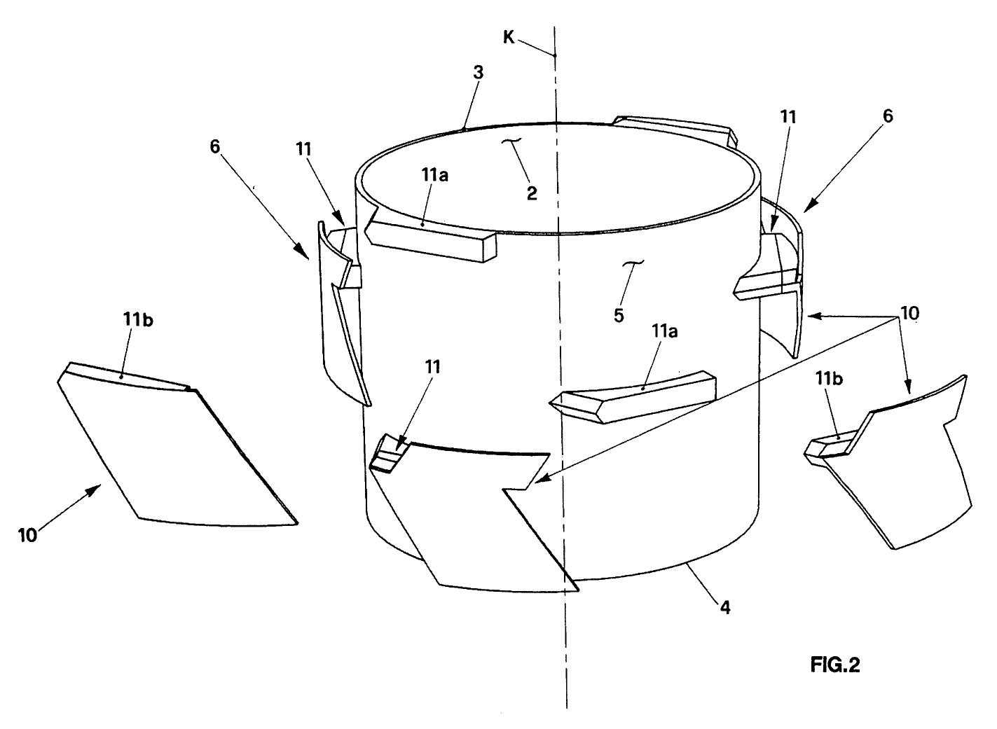

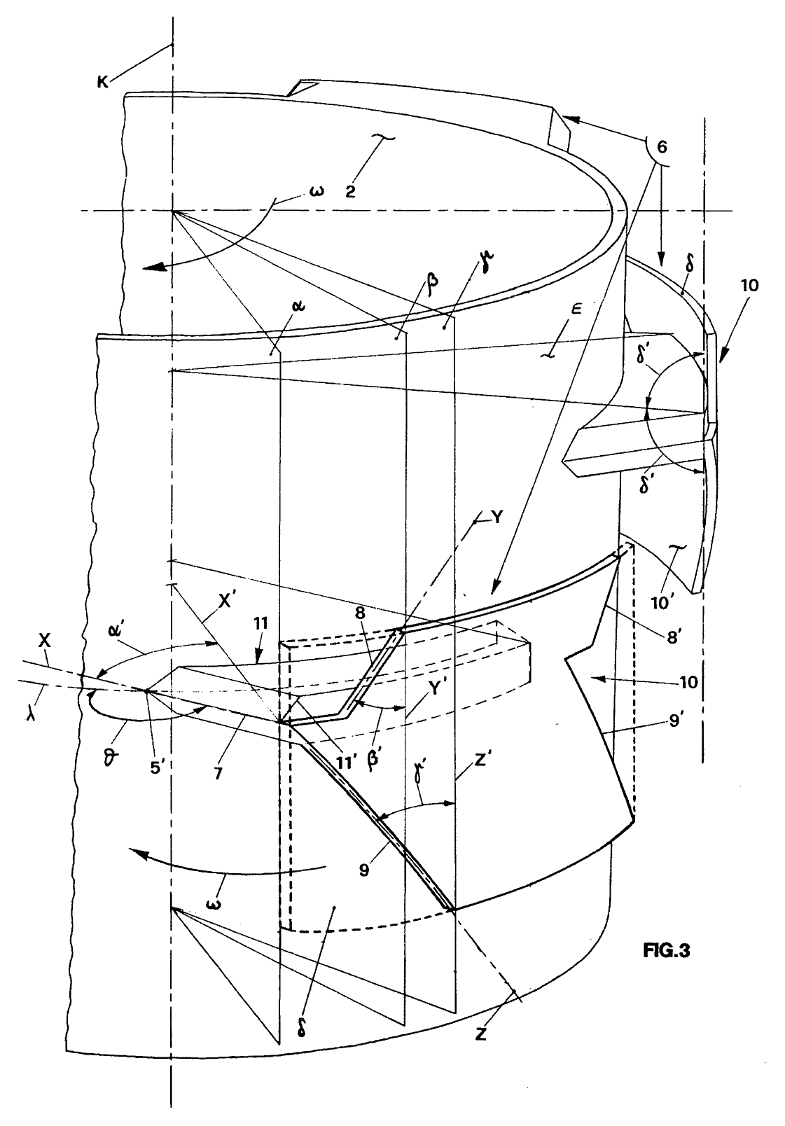

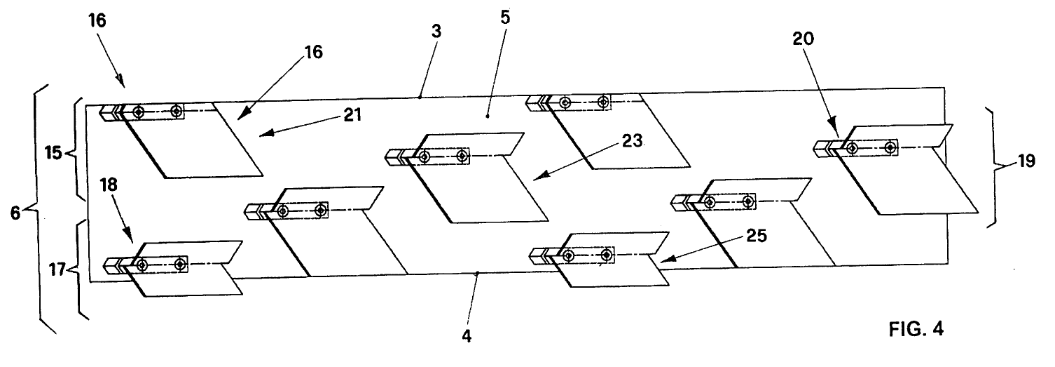

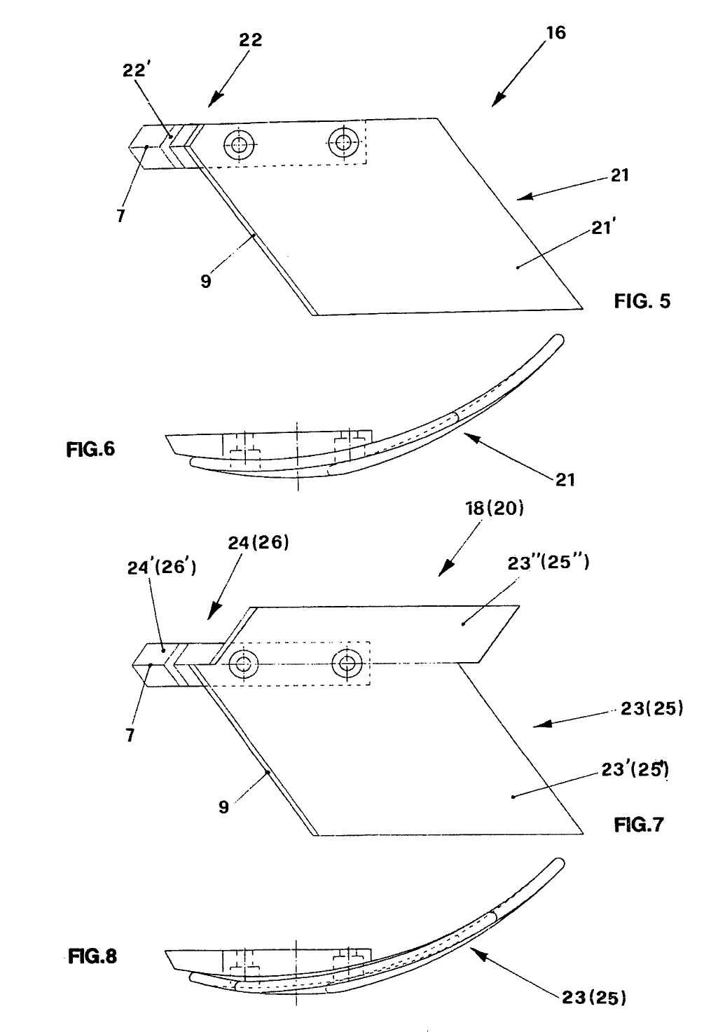

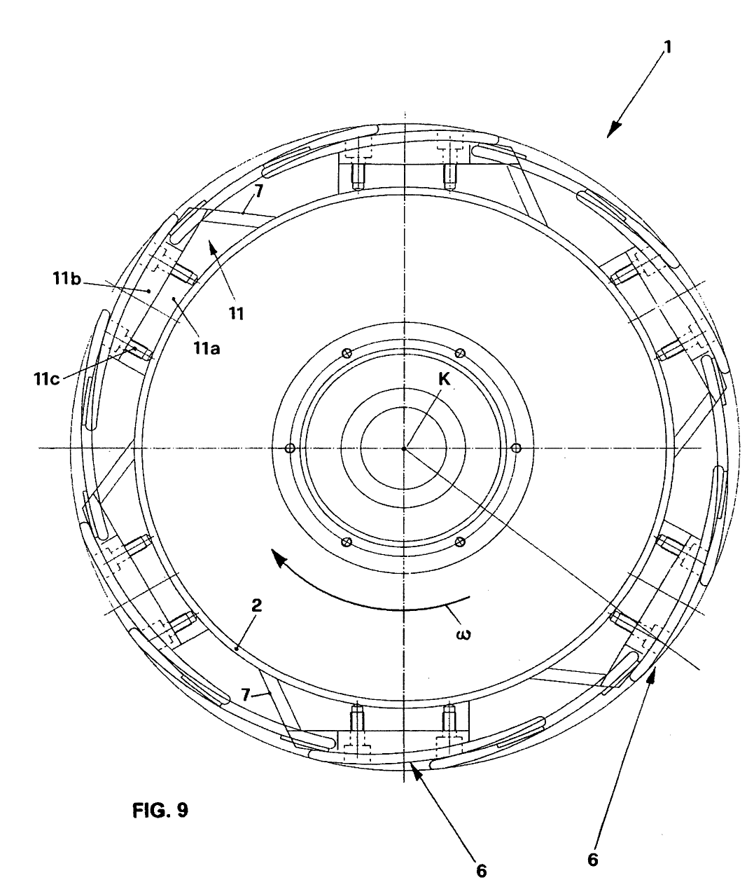

The rotor object of the invention is represented with an overall axonometric view in FIG. 1 and in FIG. 2 and with a partial and schematic axonometric view in FIG. 3, where it is indicated as a whole by 1.

It can be observed that it comprises a tubular central body 2 with substantially circular cross section, in which it is possible to identify a top base 3, a bottom base 4 and a vertical rotation axis K.

The lateral surface 5 of the central body 2 is provided with a plurality of protruding shaped blades, indicated as a whole by 6.

The rotor object of the invention can be applied to any fibrous suspension strainer, in particular of the type provided with filtering basket, where the rotor object of the invention is set rotating around the already mentioned vertical axis K according to the clockwise direction of rotation ω indicated by the arrow.

In each one of the blades 6 the front edges 7, 8, 9, alternatively called also connection edges, are constituted by all the points that during the rotation of the rotor are the first to make contact with the fibrous suspension to be cleaned.

According to the invention, in each one of the above mentioned blades 6 the direction X, Y, Z defined by at least one of the front edges 7, 8, 9 is inclined in the direction opposite the direction of rotation ω of the rotor 1 and forms an acute angle α′, β′, γ′ with any other coplanar direction X′, Y′, Z′ that intersects it, defined by the intersection of the blade 6 and any other vertical sectioning plane α, β, γ passing through the vertical rotation axis K.

Such inclination of the front edges 7, 8, 9, opposite the direction of rotation w of the rotor 1, facilitates the detachment of the contaminants from the rotor blades during rotation.

Each shaped blade 6, as shown in FIGS. 2 and 3, comprises a wing-shaped surface, indicated as a whole by 10, and a connection element 11 that connects the wing-shaped surface 10 to the outer lateral surface 5 of the central body 2.

In particular, with reference to FIG. 3, the wing-shaped surface 10 belongs to a curved surface δ that develops parallel to the rotation axis K with its concave part 10′ facing towards the lateral surface 5 of the central body 2, while the connection element 11 defines a plane ε substantially orthogonal to the axis K.

The curved surface δ and the plane ε intersect each other defining, on a vertical plane, the substantially right angles δ′ that can be observed in FIG. 3.

In particular in FIG. 4 it is possible to observe that the shaped blades, generically indicated by 6, comprise:
an upper series 15 of upper shaped blades, each one indicated by 16, arranged in correspondence with the top base 3 of the central body 2;
a lower series 17 of lower shaped blades, each one indicated by 18, arranged in correspondence with the bottom base 4 of the central body 2;
an intermediate series 19 of intermediate shaped blades, each one indicated by 20, included between the upper series 15 and the lower series 17.

It is obvious that in different embodiments the arrangement of the series of blades, as well as the number and shape of the blades present in each series, may also be different from the solution proposed and illustrated.

As regards the shaped blades, it can be observed, with reference to the FIGs. from 4 to 8, that in each upper shaped blade 16 the wing-shaped surface, indicated as a whole by 21, develops parallel to the vertical rotation axis K on one side only of the connection element 22 towards the bottom base 4 and comprises a lower wing-shaped surface 21′.

Each lower shaped blade 18 or intermediate shaped blade 20, instead, has its wing-shaped surface 23 and 25, respectively, that develops parallel to the vertical rotation axis K on opposite sides of the respective connection element 24 and 26 and comprises a lower wing-shaped surface 23′ and 25′ that develops on the side where there is the bottom base 4 and an upper wing-shaped surface 23″ and 25″ that develops on the side where there is the top base 3.

It can be observed, therefore, that most wing-shaped surfaces forming the blades develop towards the bottom base 4, so that the contaminants with filaments present in the fibrous suspension tend to slide preferably towards the bottom base 4 of the central body 2 and therefore towards the bottom of the strainer, where the contaminant outlet is generally positioned.

In this way the polluting substances with filaments remain inside the strainer for a shorter time than the fibre.

This also offers another advantage, constituted by the fact that there is less rubbing of the polluting substances against the walls with which they make contact during the cleaning process, with consequent reduced wear of the strainer.

Again with reference to FIG. 3, it can be observed that in the lower shaped blades 18 and in the intermediate shaped blades 20 the front edge 8 of each upper wing-shaped surface 23″, 25″ is positioned backward, in the direction opposite the direction of rotation ω of the rotor 1 with respect to the front edge 9 of the respective lower wing-shaped 23′, 25′, so that the front edges 8 and 9 are offset with respect to each other on the plane defined by the respective wing-shaped surface 23 and 25.

This construction characteristic, together with the convergence of the directions Y and Z of the front edges 8 and 9 in the same direction of rotation w of the rotor, gives the respective wing-shaped surface 23 and 25 a receding profile in the direction opposite the direction of rotation ω of the rotor 1, which allows the polluting substances with filaments to slide away and facilitates their detachment from the rotor.

As regards the rear edges 8′, 9′ of the wing-shaped surfaces, it can be observed that they are parallel to the corresponding front edges 8, 9 and that they also converge in the direction of rotation ω of the rotor 1.

It can also be observed that the rear edge 8′ is positioned backward with respect to the rear edge 9′ in the direction opposite the direction of rotation w of the rotor 1.

As regards each connection element 11, representative of any connection element 22, 24 and 26 of the shaped blades 16, 18, 20, respectively, it can be observed that it has a triangular profile 11′, 22′, 24′, 26′, visible in detail in the figures, converging according to the direction of rotation ω of the rotor and having the vertex positioned in correspondence with the front edge 7.

Furthermore, the front edge 7 defines an obtuse angle θ with the half line λ tangential to the outer lateral surface 5 of the central body 2 drawn in the intersection point 5′ of the outer lateral surface 5 and the front edge 7.

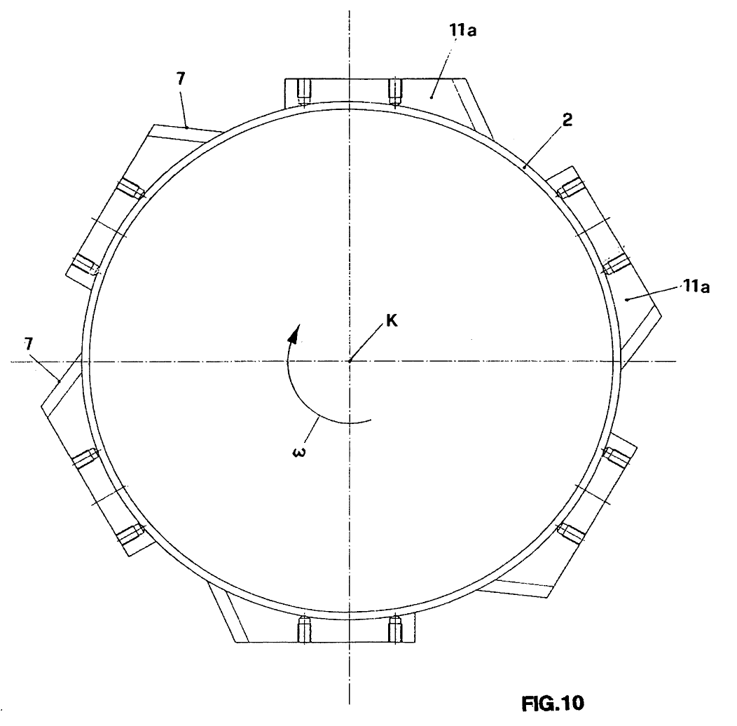

Each connection element 11, as it can be observed in particular in FIGS. 9 and 10, comprises a first part 11a belonging to the lateral surface 5 of the central body 2 and a second part 11b belonging to the respective wing-shaped surface 10, which are removably connected to each other by means of screws 11c.

Obviously, also the connection elements 22, 24 and 25 have the same configuration described regarding the connection element 11 that represents all of them.

This facilitates the installation and removal of the blades 6 when maintenance operations or repairs are necessary.

The above shows that the rotor object of the invention achieves all the goals set.

In particular, the profile of the front edges of the blades that is receding with respect to the direction of rotation of the rotor facilitates the discharge of the contaminants with filaments.

In this way greater cleanliness of the rotor and less wear of the parts of the strainer adjacent to it are obtained.

Upon implementation changes may be made in the construction of the rotor object of the invention that are neither represented, nor described and are aimed to improve the performance of the rotor or to make its construction easier and more economical.

If said changes fall within the protection scope of the following claims, they must certainly be considered covered by the present patent.

1. A rotor for fibrous suspension strainers, comprising:
a central body with substantially circular cross section, in which it is possible to identify a bottom base, a top base and a vertical rotation axis;
a plurality of shaped blades protruding from the outer lateral surface of said central body,
in each one of said blades the direction defined by at least one of the front edges is inclined in the direction opposite the direction of rotation of said rotor and forms an acute angle with any other coplanar direction that intersects it, defined by the intersection of said blade and any vertical sectioning plane passing through said vertical rotation axis.

2. A rotor according to claim 1, wherein each one of said shaped blades comprises:
a wing-shaped surface belonging to a curved surface that develops parallel to said vertical rotation axis with its concave part facing towards said outer lateral surface of said central body;
a connection element that connects said wing-shaped surface to said outer lateral surface of said central body and that defines a plane substantially orthogonal to said vertical rotation axis, said wing-shaped surface and said connection element being suited to define right angles in the intersection of said curved surface and said plane that represent them.

3. A rotor according to claim 2, wherein said shaped blades comprise:
at least one upper series of upper shaped blades arranged in correspondence with said top base of said central body;
at least one lower series of lower shaped blades arranged in correspondence with said bottom base;
at least an intermediate series of intermediate shaped blades included between said upper series and said lower series.

4. A rotor according to claim 3, wherein each upper shaped blade of said upper series of blades has its wing-shaped surface that develops parallel to said vertical rotation axis on one side only of said connection element and comprises a lower wing-shaped surface that develops on the side where there is said bottom base.

5. A rotor according to claim 3, wherein each lower shaped blade of said lower series of blades and each intermediate shaped blade of said intermediate series have the respective wing-shaped surface that develops parallel to said vertical rotation axis on opposite sides of said connection element and comprises an upper wing-shaped surface that develops on the side where there is said top base and a lower wing-shaped surface that develops on the side where there is said bottom base.

6. A rotor according to claim 4, wherein said upper wing-shaped surface has its front edge inclined in the direction opposite the direction of rotation of said rotor.

7. A rotor according to claim 4, wherein said lower wing-shaped surface has its front edge inclined in the direction opposite the direction of rotation of said rotor.

8. A rotor according to claim 4, wherein said connection element is inclined in the direction opposite the direction of rotation of said rotor.

9. A rotor according to claim 8, wherein said front edge of said connection element forms an obtuse angle with the half line tangential to said outer lateral surface of said central body drawn in the point in which said front edge intersects said outer lateral surface.

10. A rotor according to claim 5, wherein the front edge of said upper wing-shaped surface is positioned backward in the direction opposite the direction of rotation of said rotor with respect to said front edge of said lower wing-shaped surface.

11. A rotor according to claim 4, wherein the direction defined by the front edge of said lower wing-shaped surface intersects the direction defined by the front edge of said connection element.

12. A rotor according to claim 5, wherein the direction defined by the front edge of said upper wing-shaped surface and the direction defined by the front edge of said lower wing-shaped surface converge in the direction of rotation of said rotor.

13. A rotor according to claim 5, wherein the rear edge of said upper wing-shaped surface and the rear edge of said lower wing-shaped surface define directions that converge in the direction of rotation of said rotor.

14. A rotor according to claim 13, wherein said rear edge and said front edge of said upper wing-shaped surface and of said lower wing-shaped surface are parallel to each other.

15. A rotor according to claim 13, wherein said rear edge of said upper wing-shaped surface is positioned backward with respect to said rear edge of said lower wing-shaped surface, in the direction opposite the direction of rotation of said rotor.

16. A rotor according to claim 4, wherein the cross section of said front edge of said connection element has a triangular profile converging according to the direction of rotation of said rotor and having the vertex arranged in correspondence with said front edge.

17. A rotor as represented and described.
